(19) United States
(12) Patent Application Publication
(10) Pub. No.: US 2005/0201084 A1
(43) Pub. Date: Sep. 15, 2005

(54) Self-attaching lighting device

(75) Inventor: Yuan-Yuan Huang, Kuei-Jen Hsiang (TW)

Correspondence Address: FOLEY AND LARDNER;SUITE 500, 3000 K STREET NW, WASHINGTON, DC, 20007, US

(73) Assignee: Yuan-Yuan Huang

(21) Appl. No.: 10/797,048

(22) Filed: Mar. 11, 2004

(51) Int. Cl. F21L 2/00

(52) U.S. Cl. 362/157

(57) ABSTRACT

A self-attaching lighting device includes a transparent suction cup and a light source. The transparent suction cup has a cup portion for attachment to a surface, and a neck portion connected to the cup portion. The neck portion has one end remote from the cup portion and formed with a lamp recess. The light source includes a casing that is connected to the neck portion of the transparent suction cup, and a light emitting member that is mounted in the casing and that extends into the lamp recess in the neck portion of the transparent suction cup.

### BACKGROUND OF THE INVENTION

1. Field of the Invention

The invention relates to a self-attaching lighting device, more particularly to a self-attaching lighting device that includes a suction cup.

2. Description of the Related Art

A conventional lighting device for an automobile includes a base plate that has front and back surfaces, and a light source mounted on the front surface of the base plate. The back surface of the base plate is coated with adhesive means for adherence on a surface of the automobile.

The conventional lighting device is disadvantageous in that when removed, it may leave adhesive residue behind. This results in an undesirable affect on the appearance of the automobile. Moreover, the adhesive residue cannot be scraped off without subjecting the painted surface of the automobile to damage. Furthermore, the adhesive needs to be peeled off everytime the lighting device is repositioned, which is inconvenient, annoying, and time consuming.

### SUMMARY OF THE INVENTION

Therefore, the object of the present invention is to provide a self-attaching lighting device that can overcome the aforesaid drawbacks of the prior art.

According to the present invention, a self-attaching lighting device includes a transparent suction cup and a light source. The transparent suction cup has a cup portion for attachment to a surface, and a neck portion connected to the cup portion. The neck portion has one end remote from the cup portion and formed with a lamp recess. The light source includes a casing that is connected to the neck portion of the transparent suction cup, and a light emitting member that is mounted in the casing and that extends into the lamp recess in the neck portion of the transparent suction cup.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic partly sectional view of the preferred embodiment of a self-attaching lighting device according to the present invention; and

FIG. 2 is a schematic partly sectional view of the preferred embodiment to illustrate a light source when connected to a transparent suction cup.

### DETAILED DESCRIPTION OF THE PREFERRED EMBODIMENT

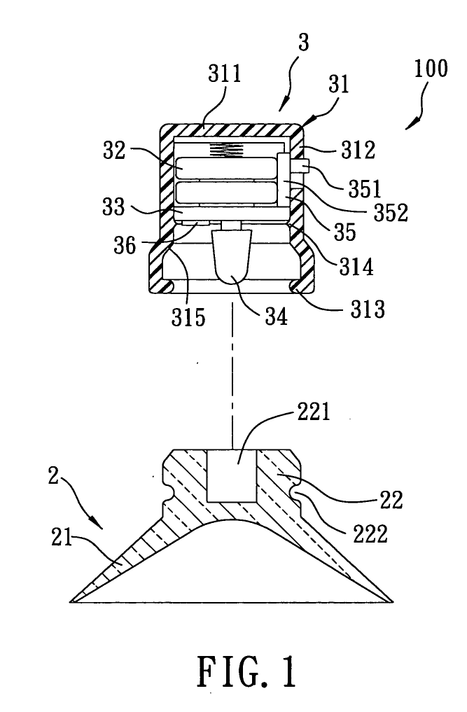

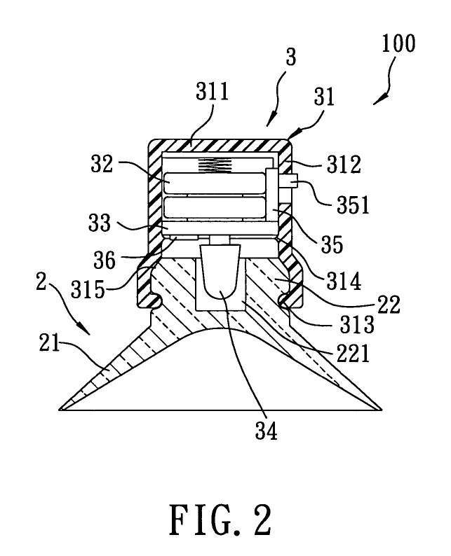

Referring to FIGS. 1 and 2, the preferred embodiment of a self-attaching lighting device 100 according to the present invention includes a transparent suction cup 2 and a light source 3.

The transparent suction cup 2 is flexible, and is made from a material, such as plastics, silicon rubber, etc. In this embodiment, the transparent suction cup 2 has a cup portion 21 for attachment to a surface in a known manner, and a neck portion 22. The neck portion 22 has a first end connected to the cup portion 21, and a second end remote from the cup portion 22 and formed with a lamp recess 221. It is noted that the second end of the neck portion 22 has a circular cross-section.

The light source 3 includes a casing 31 and a light emitting member 34. The casing 31 confines a mounting space therein, and is connected removably to the neck portion 22 of the transparent suction cup 2. In particular, the casing 31 has an open end, an annular base wall 311 opposite to the open end, and a surrounding wall 312 that extends from a periphery of the annular base wall 311 and that cooperates with the annular base wall 311 so as to define the mounting space. The surrounding wall 312 of the casing 31 is sleeved fittingly and removably on the neck portion 22 of the transparent suction cup 2 through the open end. More particularly, the neck portion 22 has an outer wall surface formed with an annular locking groove 222, while the surrounding wall 312 has an inner wall surface formed with an annular locking protrusion 313. The annular locking protrusion 313 engages removably the annular locking groove 312 when the light source 3 is connected to the transparent suction cup 2.

The light source 3 further includes a circuit board 33. The inner wall surface of the surrounding wall 312 is further formed with a radial positioning flange 314. The circuit board 33 is disposed in the mounting space in the casing 31 such that the circuit board 33 is seated on the radial positioning flange 314. The radial positioning flange 314 limits movement of the circuit board 33 in the casing 31.

The light emitting member 34, such as a light emitting diode, is disposed in the mounting space in the casing 31, and is mounted on the circuit board 33, such as by soldering.

The inner wall surface of the surrounding wall 312 is further formed with a radial inward limit shoulder 315. The casing 31 of the light source 3 is retained removably on the neck portion 22 of the transparent suction cup 2 such that the radial inward limit shoulder 315 abuts against the periphery of the second end of the neck portion 22 of the transparent suction cup 2, and such that the light emitting member 34 extends into the lamp recess 221 in the neck portion 22 of the transparent suction cup 2.

The light source 3 further includes a control circuit and a battery unit 32. The control circuit is disposed in the mounting space in the casing 31, is mounted on the circuit board 33, such as by soldering, and is coupled to the light emitting member 34. The battery unit 32, which includes a pair of battery cells in series, is received in the mounting space in the casing 31, is in contact with the circuit board 33 in a manner well known in the art, and is coupled to the control circuit.

In particular, the control circuit includes a switch unit 35 operable so as to make or break electrical connection between the battery unit 32 and the light emitting member 34. In this embodiment, the switch unit 35 includes a mechanical switch 352 that has a first terminal coupled to the battery unit 32 and a second terminal coupled to the light emitting member 34. The mechanical switch 35 is provided with a switch lever 351 that is operable so as to control electrical connection of the first terminal to the second terminal of the mechanical switch 35. The switch lever 351 extends through the surrounding wall 312 of the casing 31 so as to be operable externally of the casing 31. In an alternative embodiment, instead of a mechanical switch 352, the switch unit 35 may include a vibration sensor, a mercury switch, or any other switch type.

The control circuit further includes a light sensor 36 that makes or breaks electrical connection between the battery unit 32 and the light emitting member 34 in accordance with ambient light conditions. In particular, the light sensor 36 couples the second terminal of the mechanical switch 352 to the light emitting member 34. Preferably, the light sensor 36 is a photo-resistor.

Although the battery unit 32 of this invention is exemplified using only a pair of battery cells, it should be apparent to those skilled in the art that the actual number of battery cells may be varied as required.

In operation, when the switch lever 351 is operated so as to connect the first terminal to the second terminal of the mechanical switch 352, and when the ambient light condition is below a threshold value, such as during night time, the light sensor 36 makes electrical connection between the battery unit 32 and the light emitting member 34, whereby battery power is supplied to the light emitting member 34, thereby turning on the light emitting member 34. As a result, a light is emitted through the transparent suction cup 2. Thereafter, when the ambient light condition changes to be above the threshold value, such as during daytime, the light sensor 36 breaks the electrical connection between the battery unit 32 and the light emitting member 34. Accordingly, the supply of the battery power is inhibited, and the light emitting member 34 is turned off.

In an alternative embodiment, the control circuit may be dispensed with either the switch unit 35 or the light sensor 36.

It has thus been shown that the self-attaching lighting device of the present invention includes a transparent suction cup 2, and a light source 3 connected to the transparent suction cup 2. The construction as such permits the self-attaching lighting device 100 to be conveniently and repeatedly attached to and removed from virtually any smooth surface, such as the surface of an automobile, without affecting the appearance of the latter. Moreover, the self-attaching lighting device 100, when lit, provides noticeable visual effects. Furthermore, in order to create lively, colorful, and rich visual effects, several self-attaching lighting devices 100, each of which emits light with a distinct color, may be used simultaneously.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A self-attaching lighting device comprising:
a transparent suction cup having a cup portion for attachment to a surface, and a neck portion connected to said cup portion, said neck portion having one end remote from said cup portion and formed with a lamp recess; and
a light source including
a casing connected to said neck portion of said transparent suction cup, and
a light emitting member mounted in said casing and extending into said lamp recess in said neck portion of said transparent suction cup.

2. The self-attaching lighting device as claimed in claim 1, wherein said casing is connected removably to said neck portion of said transparent suction cup.

3. The self-attaching lighting device as claimed in claim 2, wherein said casing has a surrounding wall that is sleeved fittingly and removably on said neck portion of said transparent suction cup.

4. The self-attaching lighting device as claimed in claim 3, wherein said surrounding wall has an inner wall surface, and said neck portion has an outer wall surface,
one of said inner wall surface of said surrounding wall and said outer wall surface of said neck portion being formed with a locking groove,
the other of said inner wall surface of said surrounding wall and said outer wall surface of said neck portion being formed with a locking protrusion to engage removably said locking groove, thereby retaining removably said casing of said light source on said neck portion of said transparent suction cup.

5. The self-attaching lighting device as claimed in claim 3, wherein said surrounding wall is formed with a radial inward limit shoulder to abut against said one end of said neck portion of said transparent suction cup.

6. The self-attaching lighting device as claimed in claim 1, wherein said casing confines a mounting space therein, said light source further including a control circuit disposed in said mounting space in said casing and coupled to said light emitting member.

7. The self-attaching lighting device as claimed in claim 6, wherein said light source further includes a battery unit received in said mounting space in said casing and coupled to said control circuit.

8. The self-attaching lighting device as claimed in claim 7, wherein said control circuit includes a switch unit operable so as to make or break electrical connection between said battery unit and said light emitting member.

9. The self-attaching lighting device as claimed in claim 8, wherein said switch unit includes a mechanical switch disposed in said casing and provided with a switch lever that extends through said casing so as to be operable externally of said casing.

10. The self-attaching lighting device as claimed in claim 7, wherein said control circuit includes a light sensor that makes or breaks electrical connection between said battery unit and said light emitting member in accordance with ambient light conditions.

11. The self-attaching lighting device as claimed in claim 10, wherein said light sensor is a photo-resistor.

12. The self-attaching lighting device as claimed in claim 8, wherein said switch unit includes a vibration sensor.
